(19) United States
(12) Patent Application Publication
(10) Pub. No.: US 2019/0283140 A1
(43) Pub. Date: Sep. 19, 2019

(54) CUTTER ARBOR DAMPING DEVICE

(71) Applicant: Chiu-Lien Yu, Taichung City (TW)

(72) Inventor: Chiu-Lien Yu, Taichung City (TW)

(21) Appl. No.: 15/920,028

(22) Filed: Mar. 13, 2018

(51) Int. Cl. B23B 27/00; B23Q 11/00

(52) U.S. Cl. CPC B23B 27/002; B23Q 11/0032

(57) ABSTRACT

A cutter arbor damping device includes a rod body, a damping mechanism, and a heat-resistance element. The rod body includes a connecting end having a connecting hole, a receiving room, and a blocking wall between the connecting hole and the receiving room. The connecting end is adapted for being heated to expand the connecting hole to receive a cutter inserted therein wherein the cutter is positioned when the connecting end is cooled down. The damping mechanism is received in the receiving room and includes a vibration absorption portion contacting an inner wall of the receiving room. The heat-resistance element is disposed between the damping mechanism and the inner wall of the receiving room and includes at least one longitudinal protrusion and at least one longitudinal gap which are located between the blocking wall and the damping mechanism.

### BACKGROUND OF THE INVENTION

### Field of the Invention

The present invention relates to a cutter arbor, especially to a cutter arbor of sintering.

### Description of the Prior Art

It is widely applied that the connecting end clamps the cutter arbor by thermal expansion and contraction in the area of machine tool.

However, vibration during processing may have an adverse effect to damping. In addition, the cutter arbor has to be heated when displacing the cutter, so the cutter arbor or the components inside have to be made of metal having high heat resistance to prevent from damaging by heat.

### SUMMARY OF THE INVENTION

The main object of the present invention is to provide a cutter arbor damping device which is heat-resistant to protect the components inside and is advantageous in damping. In addition, it's easy to manufacture and assemble.

To achieve the above and other objects, the cutter arbor damping device of the present invention includes a rod body, a damping mechanism, and a heat-resistance element. The rod body includes a connecting end having a connecting hole, a receiving room, and a blocking wall between the connecting hole and the receiving room. The connecting end is adapted for being heated to expand the connecting hole to receive a cutter inserted therein wherein the cutter is positioned when the connecting end is cooled down. The damping mechanism is received in the receiving room and includes a vibration absorption portion contacting an inner wall of the receiving room. The heat-resistance element is disposed between the damping mechanism and the inner wall of the receiving room and includes at least one longitudinal protrusion and at least one longitudinal gap which are located between the blocking wall and the damping mechanism.

The present invention will become more obvious from the following description when taken in connection with the accompanying drawings, which show, for purpose of illustrations only, the preferred embodiment(s) in accordance with the present invention.

### BRIEF DESCRIPTION OF THE DRAWINGS

FIG. 1 is an illustration of the present invention;

FIG. 2 is a cross-section drawing of the present invention;

FIG. 3 is a stereogram of the present invention;

FIG. 4 is a breakdown drawing of the present invention;

FIG. 5 is a breakdown drawing showing a second embodiment of the present invention.

### DETAILED DESCRIPTION OF THE PREFERRED EMBODIMENTS

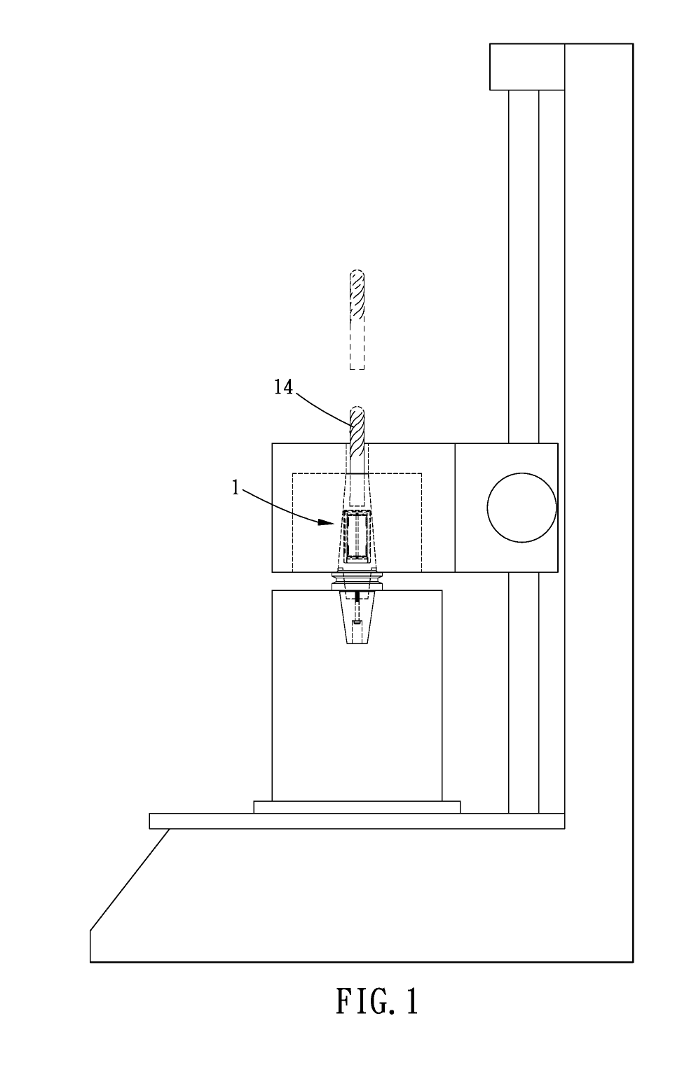

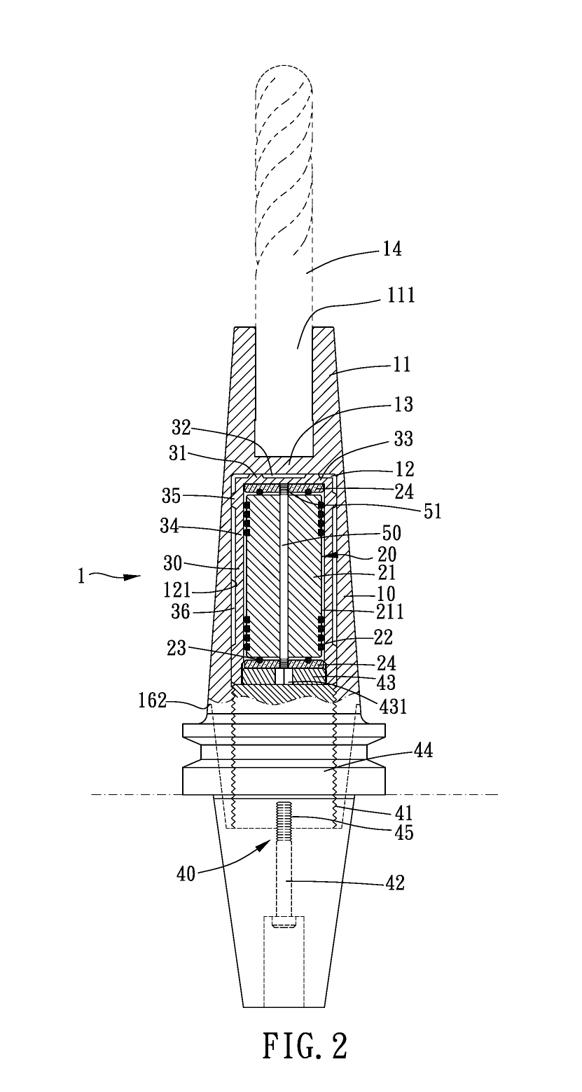

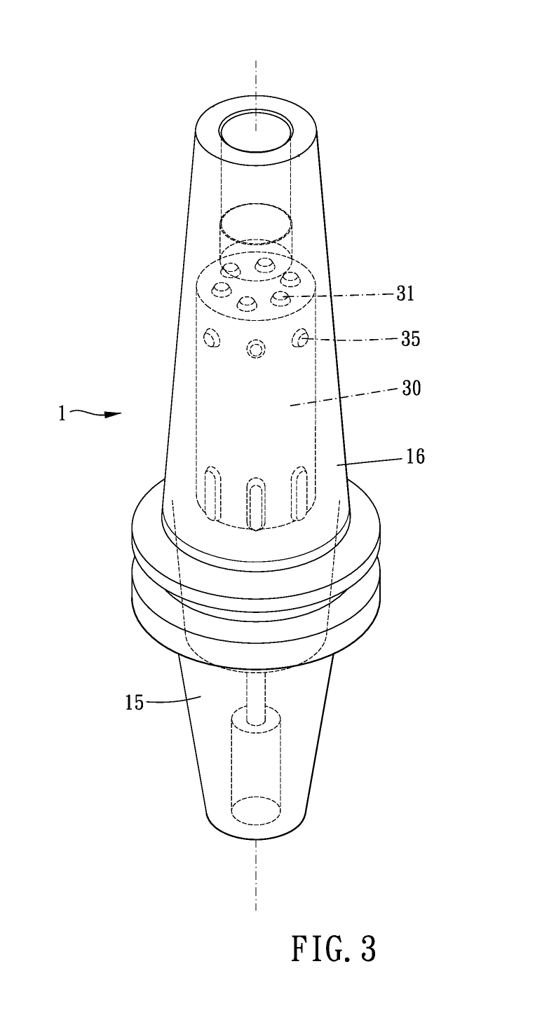

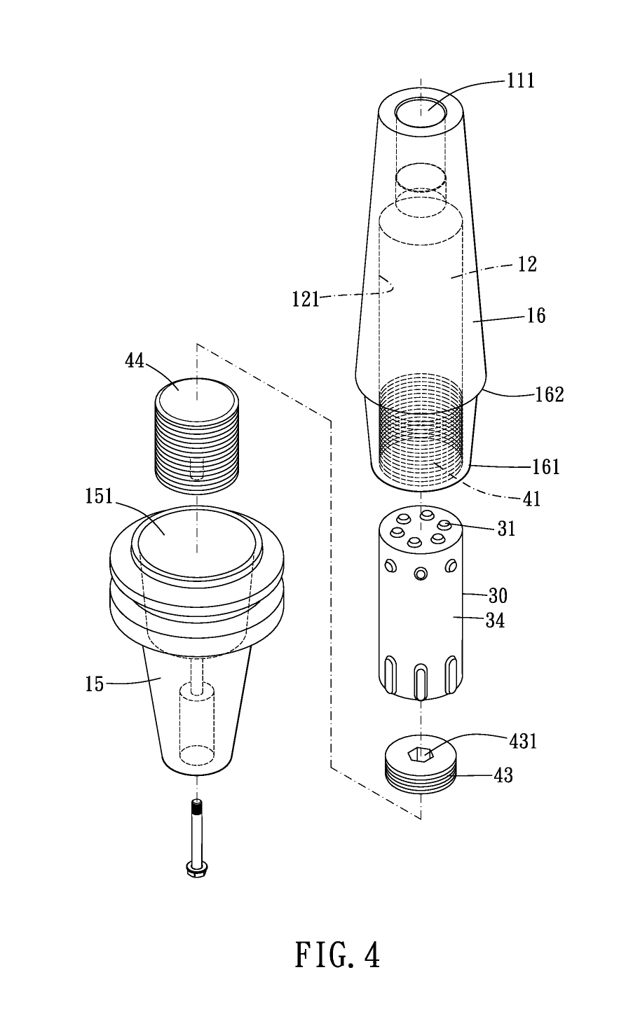

Please refer to FIG. 1 to FIG. 4, the cutter arbor damping device 1 of the present invention includes a rod body 10, a damping mechanism 20, and a heat-resistance element 30.

The rod body 10 includes a connecting end 11 having a connecting hole 111, a receiving room 12, and a blocking wall 13 between the connecting hole 111 and the receiving room 12. The connecting end 11 is adapted for being heated to expand the connecting hole 111 to receive a cutter 14 inserted therein wherein the cutter 14 is positioned when the connecting end 111 is cooled down. The damping mechanism 20 is received in the receiving room 12 and includes a vibration absorption portion contacting an inner wall 121 of the receiving room 12. The heat-resistance element 30 is disposed between the damping mechanism 20 and the inner wall of 121 the receiving room 12 and includes at least one longitudinal protrusion 31 and at least one longitudinal gap 32 which are located between the blocking wall 13 and the damping mechanism 20. Thereby, the heat-resistance element 30 protects the components therein from damaging due to heat during installing or displacing the cutter 14. In addition, the damping mechanism can reduce vibration during processing.

The damping mechanism 20 includes a damping piece 21, at least one first damping element 22 radially arranged between the heat-resistance element 30 and the damping piece 21, and at least one second damping element 23 longitudinally arranged between the heat-resistance element 30 and the damping piece 21. In the present embodiment, eight said first damping elements 22 are radially disposed on the damping piece 21, and one said second damping element 23 is disposed on each end along the longitudinal direction of the damping piece 21. Thus, damping effect along both the radial direction and the longitudinal direction is provided. The first and the second damping elements 22,23 can be but not restricted to rubber rings

The damping mechanism 20 further includes a vibration adsorption element 24 located at a side of the damping piece 21, and the second damping element 23 is located between the damping piece 21 and the vibration adsorption element 24. In the preset embodiment, one said vibration adsorption element 24 is disposed on each end along the longitudinal direction of the damping piece 21, and one said second damping element 23 is arranged between each vibration adsorption element 24 and the damping piece 21 so as to further improve the damping effect.

Each vibration adsorption element 24 has a flexibility smaller than that of the blocking wall 13 but larger than that of the first damping element 22 and that of the second damping element 23. Thus, the vibration which is not adsorbed completely by the second damping element 23 can be adsorbed by the vibration adsorption element 24, and the rigidity of the vibration adsorption element 24 is sufficient to bear the collision along the longitudinal direction. Preferably, the vibration adsorption element 24 is made of plastic which is easy to process and resists heat, such as Teflon or polyimide.

Preferably, the heat-resistance element 30 includes a plurality of said longitudinal protrusion 31 arranged spacedly. More specifically, the heat-resistance element 30 is a cylinder having an open end. The heat-resistance element 30 has a terminal wall 33 facing the blocking wall 13 and a peripheral wall 34 connecting to the terminal wall 33. The longitudinal protrusion 31 is disposed on the terminal wall 33. In the present embodiment, four said first damping elements 22 are radially disposed on each of two ends of the damping piece 21. Due to the radial gaps 36, heat cannot be transmitted to the eight first damping elements 22 so that the first damping elements 22 are protected.

The peripheral wall 34 has at least one radial protrusion 35 and at least one radial gap 36 which are located between the inner wall 121 of the receiving room 12 and the damping mechanism 20. In the present embodiment, six radial protrusions 35 are separately formed on each end of the peripheral wall 34. Thus, the radial protrusions 35 can radially position the heat-resistance element 30 and reduce the contact area between the heat-resistance element 30 and the inner wall 121.

Preferably, the damping mechanism 20 includes a damping piece 21 and a plurality of first damping elements 22 located at two ends of the damping piece 21, and the first damping elements 22 radially correspond to the radial gap 36 at least partially. In the present embodiment, each end of the damping piece 21 has four said first damping elements 22 radially disposed thereon. Thus, heat is prevented from being transmitted directly to the eight first damping elements 22 due to the radial gaps 36 so as to protect the first damping elements 22.

The first damping elements 22 are protruded above the peripheral face 211 of the damping piece 21. One said radial gap 36 is located between the peripheral wall 34 and the peripheral face 211, and an other one radial gap 36 is located between the peripheral wall 34 and the inner wall 121 of the receiving room 12. Thereby, the heat-resistance element 30 prevents from the heat transmission between the outside of the rod body 10 and the damping mechanism 20 when displacing the cutter 14 so that the damping mechanism 20 may nor damage due to heat. In addition, the damping mechanism can be made of various material.

The rod body 10 includes a first section 15, a second section 16, and a threading member 40. The second section 16 is hollow and has said the connecting end 11 and said blocking wall 13. The damping mechanism 20 is received in the second section 16. The threading member 40 is adjacent to the damping mechanism 20. The threading mechanism 40 includes at least one threaded element threadedly disposed on the second section 16, and a bolt 42 received in the first section 15 and screwed with the threaded element. The receiving room 12 is enclosed by the first section 15 and the second section 16. More specifically, the second section 16 is formed with a threaded hole 41 therein. The threading member 40 includes a first nut 43 and a second nut 44 which are screwed into the threaded hole 41. The first nut 43 is adjacent to the damping mechanism 20. The bolt 42 is screwed with the second nut 44. The first nut 43 is axially formed with a polygonal hole 431 for a driving tool to engage. The second nut 44 is axially formed with an internal threaded hole 45 screwed with the bolt 42. The first section 15 has an opening 151. The second section 16 has an insertion section 161 inserted into the opening 151 and a radial flange 162 axially abutting against the first section 15. In the present embodiment, the first nut 43 is formed with a hexagon hole, so the position of the first nut 43 can be adjusted by a hexagon wrench. Thereby, the axial position of the damping mechanism 20 can be adjusted. In addition, the second nut 44 abuts against the second nut 43 to prevent the first nut 43 from falling. The bolt 42 abuts against not only the second nut 44 but also the first section 15 so as to pull the second section 16 toward the first section 15. The radial flange 162 can restrict the relative position of the first section 15 and the second section 16. In other possible embodiments, the threading member can include only the second nut 44. The second nut 44 is first screwed, and the second section 16 is pulled by the bolt 42.

The heat-resistance element 30 can be made of porous cermet oxide. Preferably, the heat-resistance element 30 is made of cermet oxide having high temperature stability, high strength, and low thermal-conductivity, such as zirconium oxide, so as to prevent from damaging due to heat.

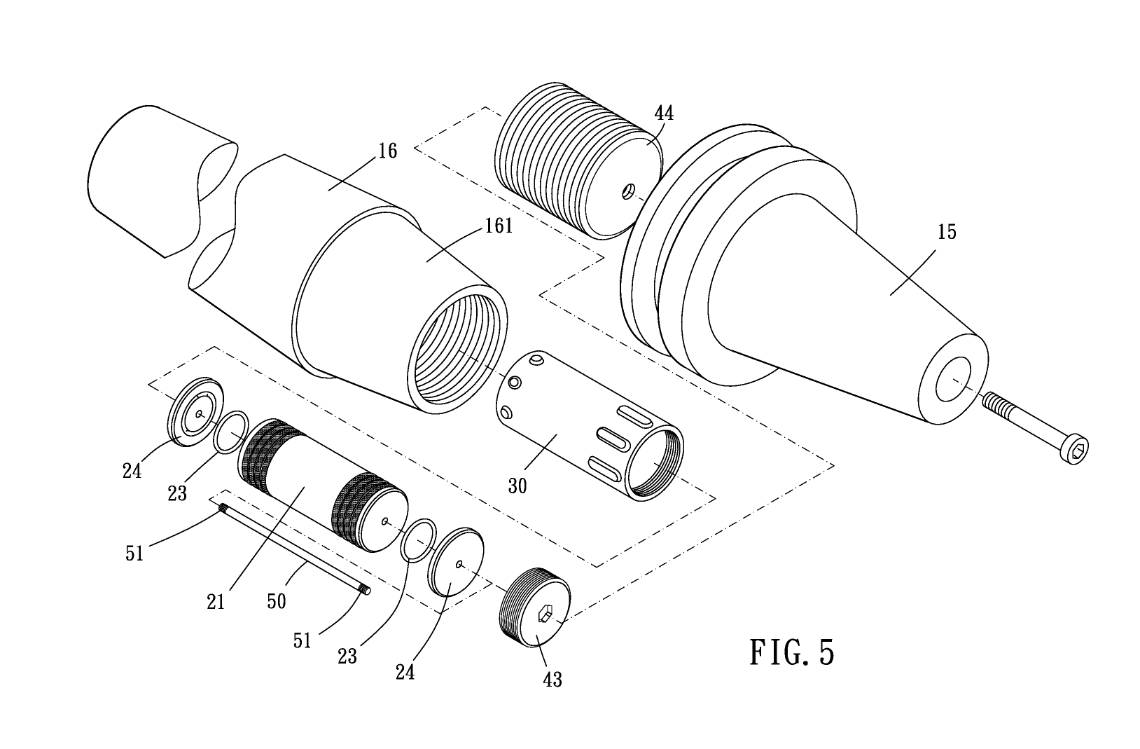

In another embodiment shown in FIG. 5, a threaded pin 50 is inserted through the heat-resistance element 30. The threaded pin 50 has threaded sections 51 at two ends thereof. The two vibration adsorption elements 24 are screwed with the two threaded sections 51 respectively. Thereby, the components are positioned precisely, and the relative position of the two vibration adsorption elements 24 can be adjusted. Preferably, a terminal end of each of the threaded section 51 is flush with a terminal end of its corresponding vibration adsorption element 24 or is received in the corresponding vibration adsorption element 24. Thus, the hard threaded pin 50 is prevented from contacting the heat-resistance element 30 directly to reduce damping effect.

In conclusion, the heat-resistance element of the present invention can protect the components inside the rod body from damaging by heat, and the damping mechanism inside the rod body provides excellent damping effect.

What is claimed is:

1. A cutter arbor damping device, including:
a rod body, including a connecting end having a connecting hole, a receiving room, and a blocking wall between the connecting hole and the receiving room, the connecting end being adapted for being heated to expand the connecting hole to receive a cutter inserted therein wherein the cutter is positioned when the connecting end is cooled down;
a damping mechanism, received in the receiving room, including a vibration absorption portion contacting an inner wall of the receiving room;
a heat-resistance element, disposed between the damping mechanism and the inner wall of the receiving room, including at least one longitudinal protrusion and at least one longitudinal gap which are located between the blocking wall and the damping mechanism.

2. The cutter arbor damping device of claim 1, wherein the damping mechanism includes a damping piece, at least one first damping element radially arranged between the heat-resistance element and the damping piece, and at least one second damping element longitudinally arranged between the heat-resistance element and the damping piece.

3. The cutter arbor damping device of claim 2, wherein the damping mechanism further includes at least one vibration adsorption element located at a side of the damping piece, the second damping element is located between the damping piece and the vibration adsorption element.

4. The cutter arbor damping device of claim 3, wherein the vibration adsorption element has a flexibility smaller than that of the blocking wall but larger than that of the first damping element and that of the second damping element.

5. The cutter arbor damping device of claim 1, wherein the heat-resistance element includes a plurality of said longitudinal protrusions, the longitudinal protrusions are arranged spacedly.

6. The cutter arbor damping device of claim 1, wherein the heat-resistance element is a cylinder having an open end, the heat-resistance element includes a terminal wall facing the blocking wall and a peripheral wall connecting to the terminal wall, the longitudinal protrusion is disposed on the terminal wall.

7. The cutter arbor damping device of claim 6, wherein the peripheral wall has at least one radial protrusion and at least one radial gap which are located between the inner wall of the receiving room and the damping mechanism.

8. The cutter arbor damping device of claim 7, wherein the damping mechanism includes a damping piece and a plurality of first damping elements located at two ends of the damping piece, the first damping elements radially correspond to the radial gap at least partially

9. The cutter arbor damping device of claim 8, wherein the first damping elements protrude above a peripheral face of the damping piece, one said radial gap is formed between the peripheral wall and the peripheral face of the damping piece, one another said radial gap is formed between the peripheral wall and the inner wall of the receiving room.

10. The cutter arbor damping device of claim 1, wherein the rod body includes a first section, a second section, and a threading element, the second section is hollow and has said connecting end and said blocking wall, the damping mechanism is received in the second section, the threading element is adjacent to the damping mechanism, the threading member includes at least one threaded element threadedly disposed on the second section, and a bolt received in the first section and screwed with the threaded element, the receiving room is enclosed by the first section and the second section.

11. The cutter arbor damping device of claim 10, wherein the second section is formed with a threaded hole therein, the threading member includes a first nut and a second nut which are screwed into the threaded hole, the first nut is adjacent to the damping mechanism, the bolt is screwed with the second nut.

12. The cutter arbor damping device of claim 9, wherein the rod body includes a first section, a second section, and a threading element, the second section is hollow and has said connecting end and said blocking wall, the damping mechanism is received in the second section, the threading element is adjacent to the damping mechanism, the threading member includes at least one threaded element threadedly disposed on the second section, and a bolt received in the first section and screwed with the threaded element, the receiving room is enclosed by the first section and the second section; the second section is formed with a threaded hole therein, the threading member includes a first nut and a second nut which are screwed into the threaded hole, the first nut is adjacent to the damping mechanism, the bolt is screwed with the second nut; the first nut is axially formed with a polygonal hole for a driving tool to engage, the second nut is axially formed with an internal threaded hole screwed with the bolt; the heat-resistance element includes a plurality of said longitudinal protrusions, the longitudinal protrusions are arranged spacedly; the damping mechanism includes two second damping elements, one of the second damping elements is axially disposed between the heat-resistance element and an end of the damping piece, the other one of the second damping elements is axially disposed between the first nut and an other end of the damping piece; the vibration adsorption element has a flexibility smaller than that of the blocking wall but larger than that of the first damping element and that of the second damping element; the first section has an opening, the second section has an insertion section inserted into the opening and a radial flange axially abutting against the first section.

13. The cutter arbor damping device of claim 3, wherein a threaded pin is inserted through the heat-resistance element, the threaded pin has threaded sections at two ends thereof, two said vibration adsorption elements are screwed with the two threaded sections respectivewly.

14. The cutter arbor damping device of claim 13, wherein a terminal end of each of the threaded section is flush with a terminal end of its corresponding vibration adsorption element or is received in the corresponding vibration adsorption element.

15. The cutter arbor damping device of claim 1, wherein the heat-resistance element is made of porous cermet oxide.
